(19) United States
(12) Patent Application Publication
(10) Pub. No.: US 2026/0212372 A1
(43) Pub. Date: Jul. 23, 2026

(54) EMISSION SOURCE CONTRIBUTION EVALUATION SYSTEM FOR CHECKING CONTRIBUTION LEVEL OF EXPOSURE TO ENVIRONMENTAL HARMFUL FACTOR

(71) Applicant: Daegu Catholic University Industry Academic Cooperation Foundation, Gyeongsan-si (KR)

(72) Inventor: Won Ho Yang, Daegu (KR)

(73) Assignee: Daegu Catholic University Industry Academic Cooperation Foundation, Gyeongsan-si (KR)

(21) Appl. No.: 19/355,855

(22) Filed: Oct. 10, 2025

(30) Foreign Application Priority Data
Nov. 14, 2024 (KR) 10-2024-0162212

(51) Int. Cl. G06Q 30/018

(52) U.S. Cl. CPC G06Q 30/018

(57) ABSTRACT

An emission source contribution evaluation system for checking an exposure contribution level of an environmental harmful factor, comprising: a communication unit configured to receive at least one of residential area monitoring data and emission source monitoring data from the outside; and a controller configured to store information about multiple emission sources, and, using an artificial intelligence model, perform concentration analysis, correlation analysis, principal component analysis, factor analysis, and cluster analysis based on the monitoring data received from the communication unit, and evaluate a contribution level of each of multiple emission sources based on the analysis results and the emission source information.

### GOVERNMENT LICENSE STATEMENT

This invention was made with the support of the National Research and Development Project of the Republic of Korea (Project Unique Number: 2480000067; Project Number: RS-2021-KE002003), funded by the Ministry of Environment and managed by the Korea Environmental Industry & Technology Institute. The research was conducted under the program “Core Technology Development Project for the Prevention and Management of Environmental Diseases,” specifically the project entitled “Development of Source Tracking Technology for Emission Sources in Environmentally Vulnerable Areas,” performed by the DAEGU CATHOLIC UNIVERSITY INDUSTRY ACADEMIC COOPERATION FOUNDATION during the period from Jan. 1, 2024 to Dec. 31, 2024.

### CROSS-REFERENCE TO RELATED APPLICATIONS

This application claims the priority of Korean Patent Application No. 10-2024-0162212 filed on Nov. 14, 2024, in the Korean Intellectual Property Office, the disclosure of which is incorporated herein by reference.

### BACKGROUND

### Field

The present disclosure relates to an emission source contribution evaluation system capable of assessing a contribution level of exposure to an environmental harmful factor, and more particularly, to an emission source contribution evaluation system that identifies the contribution level of a hazardous substance emission source based on exposure data collected from a residential area.

### Description of the Related Art

Generally, in order to establish an effective reduction strategy to improve local air quality, particularly to address high concentrations of fine dust and reduce exposure to air pollutants in local communities, it is important to accurately identify pollutant emission characteristics from all facilities in industrial sites in real time or near real time. In existing industrial sites, pollutant emissions have mainly been measured using intermittent methods or continuous methods with fixed installations. However, such conventional testing methods are insufficient to identify the impacts of complex chemical reactions in the atmosphere, the long-range transport of air pollutants, and local emission sources on atmospheric quality. Recently, measurement methods have expanded from fixed ground-based observations to mobile continuous measurements and three-dimensional stereoscopic observations capable of estimating emission amounts.

However, the existing methods have problems in that identifying a pollutant emission source takes a long time, and securing pollutant concentration data separately is required, making the process complicated and inefficient. In particular, there is a problem with the accuracy of identification in industrial complexes or areas where pollutant-emitting companies are concentrated.

### RELATED ART DOCUMENT

### Patent Document

(Patent Document 1) Korean Registered Patent No. 10-2129931 (Pollution source tracking method using drone)

### SUMMARY

Accordingly, an object of the present disclosure is to provide an emission source contribution evaluation system that identifies the contribution level of exposure to an environmental harmful factor and evaluates the contribution level of each emission source. This is achieved by analyzing emission concentrations, correlation analysis, principal component analysis, factor analysis, and cluster analysis of hazardous substances using residential area environmental monitoring data and emission source monitoring data.

In order to achieve the above-described objects, according to an aspect of the present disclosure, an emission source contribution evaluation system for assessing the exposure contribution level of an environmental harmful factor includes: a communication unit configured to receive at least one of residential area environmental monitoring data and emission source monitoring data from the outside; and a controller configured to store information on multiple emission sources and to analyze emission concentrations, correlation analysis, principal component analysis, factor analysis, and cluster analysis using an artificial intelligence model based on the received data, and to evaluate the contribution level of each emission source based on the analysis results and the stored emission source information. The contribution level of each emission source may thereby be evaluated by analyzing hazardous substance emission concentrations, correlation, principal components, factors, and clusters with an artificial intelligence model, using residential area environmental monitoring data and emission source monitoring data, so that emissions from emission source companies can be managed to improve the atmospheric environment.

Here, when at least one of the residential area environmental monitoring data and the emission source monitoring data is not received from the outside, the controller collects emitted substances from multiple emission sources and predicts the emission amounts of hazardous substances based on emission amount data classified by industry. This allows the emission amounts of hazardous substances to be predicted according to substance type and the emission amounts of multiple emission sources.

Further, the controller stores information on multiple emission sources, the emission amounts of hazardous substances from the emission sources, and an atmospheric dispersion model for the emission amounts. When at least one of the residential area environmental monitoring data or the emission source monitoring data is not received from the outside, the controller collects at least one of actual measurement data or monitoring data for the emission amounts of hazardous substances from the emission sources and predicts the concentrations of emitted hazardous substances for each emission source using the atmospheric dispersion model. By doing so, even without residential area environmental monitoring data and emission source monitoring data, the atmospheric dispersion model can be used to predict the concentrations of emitted hazardous substances for each emission source in the residential area.

Here, the actual measurement data and the monitoring data include position information comprising latitude and longitude of the emission source, wind direction, wind speed, distance scale, and concentrations of hazardous substances of the emission source. By doing so, the movement and dispersion of hazardous substances can be more accurately predicted under various situations and conditions.

In addition, the atmospheric dispersion model may be expressed by the following equation, such that the movement and dispersion of hazardous substances are mathematically represented to accurately calculate the exposure concentrations of hazardous substances for receptors in various regions.

$$level = \frac{Q}{{πσ}_{y} {σ}_{z} μ} exp [ - \frac{1}{2} {( \frac{H}{{σ}_{z}} )}^{2} ]$$

Q=pollution level of emission source (unit: g/s)
σ_{y}, σ_{z}=wind direction dispersion standard deviation of plume
μ=wind speed (unit: m/s)
H=effective chimney height (unit: m)
level=pollution level per grid

$${σ}_{y} = {a}_{y} \times {( \frac{x}{1000} )}^{{b}_{y}}$$

$${σ}_{z} = {a}_{z} \times {( \frac{x}{1000} )}^{{b}_{x}}$$

x=distance between emission source and center of grid (unit: m)

The emission source contribution evaluation system further includes a display unit configured to display analysis results of concentration analysis, correlation analysis, principal component analysis, factor analysis, and cluster analysis, and the controller controls the display unit to display the concentrations and ratios of hazardous substances for each of various receptors and emission sources based on a statistical technique. By doing so, the concentrations and ratios of hazardous substances for the receptors and the emission sources can be easily identified and managed.

In addition, the controller may display the evaluated contribution level of each of multiple emission sources for each of various receptors, so that the emissions of hazardous substances from the emission sources can be controlled and improved according to the contribution level.

According to the present disclosure, the contribution level of each emission source is evaluated using information on multiple emission sources by performing emission concentration analysis, correlation analysis, principal component analysis, factor analysis, and cluster analysis of hazardous substances with an artificial intelligence model, based on residential area environmental monitoring data and emission source monitoring data. As a result, the emissions of hazardous substances from emission source companies can be managed to improve the atmospheric environment.

Further, the emission amounts of hazardous substances may be predicted based on the types of emitted substances and the emission amounts from multiple emission sources.

Further, even in the absence of residential area environmental monitoring data and emission source monitoring data, the atmospheric dispersion model is used to predict the concentrations of emitted hazardous substances from each of multiple emission sources in residential areas.

Further, the transport and dispersion of hazardous substances may be more accurately predicted by taking into account various situations and conditions.

Further, the transport and dispersion of hazardous substances are quantitatively expressed to accurately calculate the concentrations of hazardous substances at receptors across various regions.

Further, when the concentrations and ratios of hazardous substances for each of multiple emission sources are displayed on a display unit, the concentrations and ratios of hazardous substances for both receptors and emission sources can be easily identified and managed.

Further, the emissions of hazardous substances from the emission source may be reduced and managed according to the contribution level.

The effects of the present disclosure are not limited to the above-described effects, and other effects not mentioned herein will be readily understood by those of ordinary skill in the art from the following detailed description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a control block diagram of an emission source contribution evaluation system which checks an exposure contribution level of an environmental harmful factor according to the present disclosure;

FIG. 2 is a flowchart of a first embodiment of an emission source contribution evaluation method which checks an exposure contribution level of an environmental harmful factor according to the present disclosure;

FIG. 3 is a flowchart of a second embodiment of an emission source contribution evaluation method which checks an exposure contribution level of an environmental harmful factor;

FIG. 4 is a flowchart of a third embodiment of an emission source contribution evaluation method which checks an exposure contribution level of an environmental harmful factor;

FIG. 5 is a flowchart of a fourth embodiment of an emission source contribution evaluation method which checks an exposure contribution level of an environmental harmful factor;

FIG. 6 is a flowchart and a result exemplary diagram of emission source tracking and contribution level evaluation of an emission source contribution evaluation system which checks an exposure contribution level of an environmental harmful factor;

FIG. 7 is an exemplary diagram of finding by industry type in inquiry of an air pollutant source and an emission list status;

FIG. 8 is an exemplary diagram of finding by material in inquiry of an air pollutant source and an emission list status; and

FIG. 9 is an exemplary view of data analysis based on a statistical technique for tracking an emission source and evaluating a contribution level.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Hereinafter, an emission source contribution evaluation system 1 which finds an exposure contribution of environmental harmful factors according to an exemplary embodiment of the present disclosure will be described in detail with reference to the accompanying drawings.

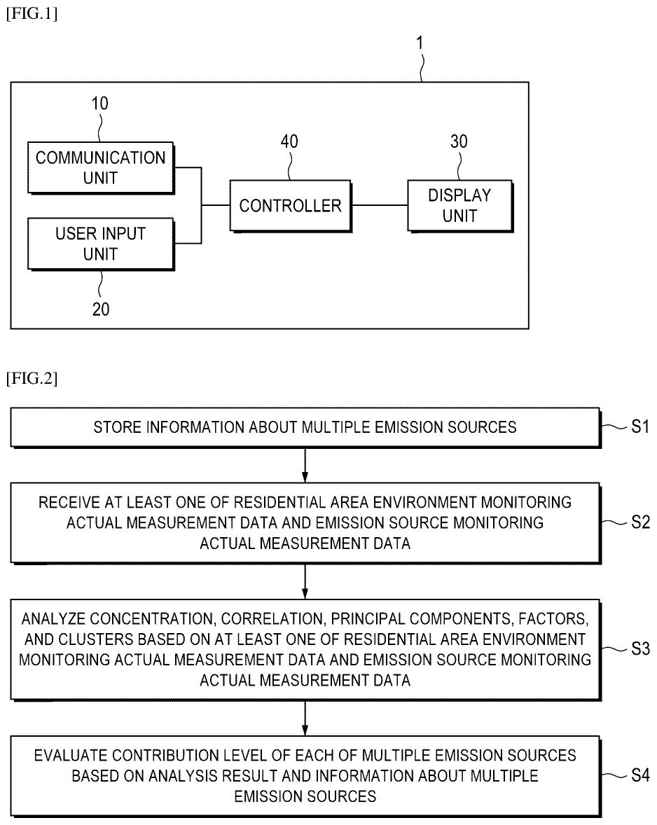

FIG. 1 is a control block diagram of an emission source contribution evaluation system 1 which checks an exposure contribution level of an environmental harmful factor according to the present disclosure.

The emission source contribution evaluation system 1 which checks an exposure contribution level of an environmental harmful factor includes a communication unit 10, a user input unit 20, a display unit 30, and a controller 40.

The communication unit 10 receives at least one of residential area environmental monitoring actual measurement data and emission source monitoring actual measurement data from the outside. The communication unit 10 performs wireless communication and the wireless communication includes at least one of IR communication, RF, Zigbee, and Bluetooth. The communication unit 10 receives an image signal to transmit the image signal to the controller 40 to be described below and may be implemented in various manners in response to a specification of the received image signal and an implementation type of a user terminal. For example, the communication unit 10 may receive a radio frequency (RF) signal transmitted from a broadcasting station (not illustrated) in a wireless manner or receives a composite video, a component video, super video, SCART, and an image signal according to a high definition multimedia interface (HDMI) specification in a wired manner. When the image signal is a broadcasting signal, the communication unit 10 may include a tuner which tunes the broadcasting signal by channels.

The user input unit 20 may be configured by an input unit which allows a user to input a user command. The user input unit 20 receives a user's touch input or a remote input of the user using a remote controller to transmit the touch input or the remote input to the controller 40. Further, the user input unit 20 receives a voice input spoken by the user to transmit the voice signal to the controller 40. In this case, the user input unit 20 may be implemented by a microphone. The user input unit 20 may independently perform the signal processing for the received voice signal. However, a type of the user input which may be received by the user input unit 20 is not limited thereto, and for example, the user input through motion recognition may also be received.

The display unit 30 may display analysis results of concentration analysis, correlation analysis, principal component analysis, factor analysis, and cluster analysis. The display unit 30 displays an image based on the image signal processed by the image processing. The implementation method of the display unit 30 is not limited and for example, the display unit may be implemented by various display methods, such as liquid crystal, plasma, light-emitting diode, organic light-emitting diode, surface conduction electron-emitter, carbon nano-tube, or nano-crystal.

The display unit 30 may further include an additional configuration according to the implementation method. For example, when the display unit 30 is a liquid crystal type, the display unit 30 includes a liquid crystal display panel (not illustrated), a backlight unit (not illustrated) which supplies light, and a panel driving substrate (not illustrated) which operates a panel (not illustrated). The display unit 30 may include a voice recognition result as information about a recognized voice. Here, the voice recognition result may be implemented by various forms, such as texts, graphics, and icons and the texts include characters and numbers. The display unit 30 may further display candidate commands and application information according to a voice recognition result. The user may check whether a voice is correctly recognized by the voice recognition result displayed on the display unit 30 and selects a command corresponding to a voice spoken by the user, among the displayed candidate commands or selects information related to the voice recognition result by manipulating the user input unit 20 provided on the remote controller.

The controller 40 stores information about multiple emission sources and analyzes concentrations, and performs correlation analysis, principal component analysis, factor analysis, and cluster analysis based on at least one of residential area environmental monitoring data and emission source monitoring data received from the communication unit 10. The controller then evaluates the contribution level of each of multiple emission sources based on the analysis results and the stored information about the emission sources.

When at least one of the residential area environment monitoring actual measurement data and emission source monitoring actual measurement data is not received from the outside, the controller 40 collects emissions from multiple emission sources and may predict the emission amounts of hazardous substances based on industry-specific emission data.

The controller 40 stores information on multiple emission sources, the emission amounts of hazardous substances from multiple emission sources, and an atmospheric dispersion model for the emission amounts of hazardous substances. If at least one of the residential area environmental monitoring data and emission source monitoring data is not received from the outside, the controller collects available measurement or monitoring data on the emission amounts of hazardous substances from multiple emission sources and may predict the concentrations of emitted hazardous substances for each of multiple emission sources based on the atmospheric dispersion model.

The controller 40 may control the display unit 30 to display the concentrations and ratios of hazardous substances for each of various receptors and emission sources using statistical techniques.

The controller 40 may display the evaluated contribution level of each of multiple emission sources for each of the various exposure sources.

The actual measurement data and monitoring data may include positional information such as the latitude and longitude of the emission source, wind direction, wind speed, distance scale, and the concentrations of hazardous substances at the emission source.

The atmospheric dispersion model is formed by the following Equation.

$$level = \frac{Q}{{πσ}_{y} {σ}_{z} μ} exp [ - \frac{1}{2} {( \frac{H}{{σ}_{z}} )}^{2} ]$$

Q=pollution level of emission source (unit: g/s)
σ_{y}, σ_{z}=wind direction dispersion standard deviation of plume
μ=wind speed (unit: m/s)
H=effective chimney height (unit: m)
level=pollution level per grid

$${σ}_{y} = {a}_{y} \times {( \frac{x}{1000} )}^{{b}_{y}}$$

$${σ}_{z} = {a}_{z} \times {( \frac{x}{1000} )}^{{b}_{x}}$$

x=distance between emission source and center of grid (unit: m)

FIG. 2 is a flowchart of a first embodiment of an emission source contribution evaluation method for evaluating an exposure contribution level of an environmental harmful factor according to the present disclosure.

Information about multiple emission sources is stored in step S1.

At least one of the residential area environment monitoring actual measurement data and the emission source monitoring actual measurement data is received in step S2.

A concentration analysis, correlation analysis, principal component analysis, factor analysis, and cluster analysis are performed based on at least one of the residential area monitoring data and the emission source monitoring data in step S3.

A contribution level of each of multiple emission sources is evaluated based on an analysis result and information about multiple emission sources in step S4.

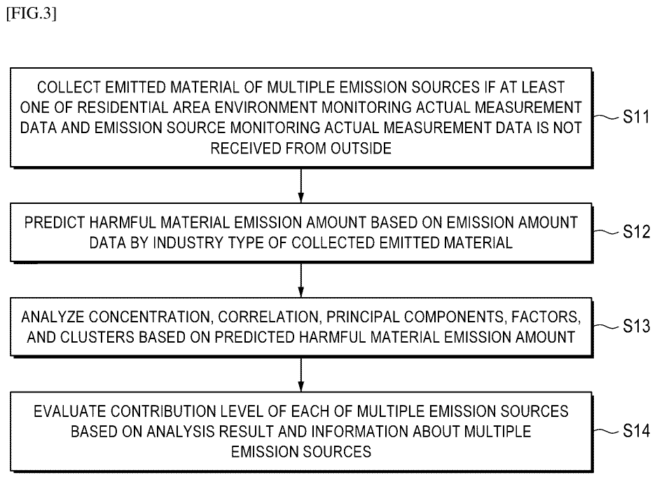

FIG. 3 is a flowchart of a second embodiment of an emission source contribution evaluation method which checks an exposure contribution level of an environmental harmful factor.

If at least one of the residential area environment monitoring actual measurement data and the emission source monitoring actual measurement data is not received from the outside, an emitted material from multiple emission sources is collected in step S11.

The emission amounts of hazardous substances are predicted based on industry-specific emission data for the collected emissions in step S12.

The concentration analysis, correlation analysis, principal component analysis, factor analysis, and cluster analysis are performed based on the predicted emission amounts of hazardous substance in step S13.

A contribution level of each of multiple emission sources is evaluated based on an analysis result and information about multiple emission sources in step S14.

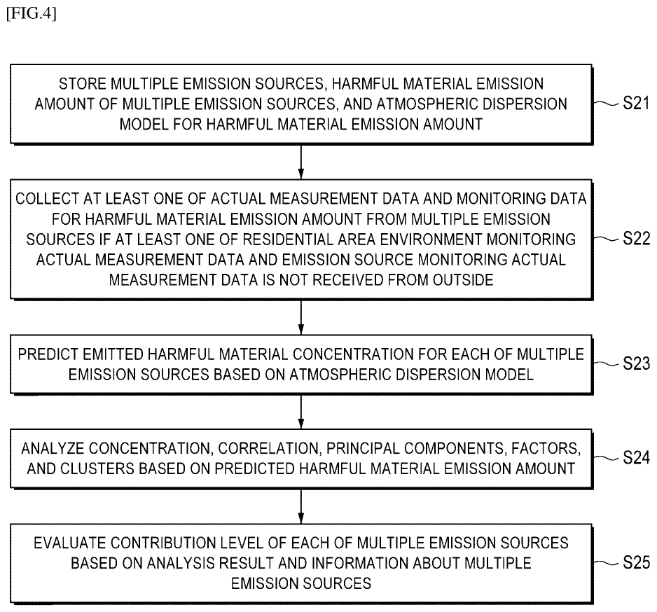

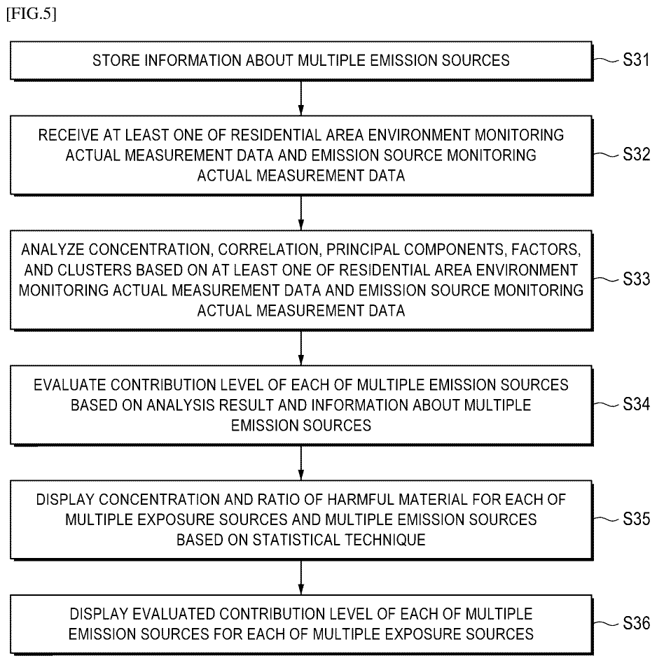

FIG. 4 is a flowchart of a third embodiment of an emission source contribution evaluation method which checks an exposure contribution level of an environmental harmful factor.

Information on multiple emission sources, the emission amounts of hazardous substances from multiple emission sources, and an atmospheric dispersion model for the emission amounts of hazardous substances are stored.in step S21.

If at least one of the residential area environment monitoring actual measurement data and the emission source monitoring actual measurement data is not received from the outside, at least one of actual measurement data or monitoring data on the emission amounts of hazardous substances from multiple emission sources is collected in step S22.

The concentrations of emitted hazardous substances for each of multiple emission sources are predicted based on the atmospheric dispersion model in step S23.

The concentration analysis, correlation analysis, principal component analysis, factor analysis, and cluster analysis are performed based on the predicted emission amounts of hazardous substances in step S24.

A contribution level of each of multiple emission sources is evaluated based on an analysis result and information about multiple emission sources in step S25.

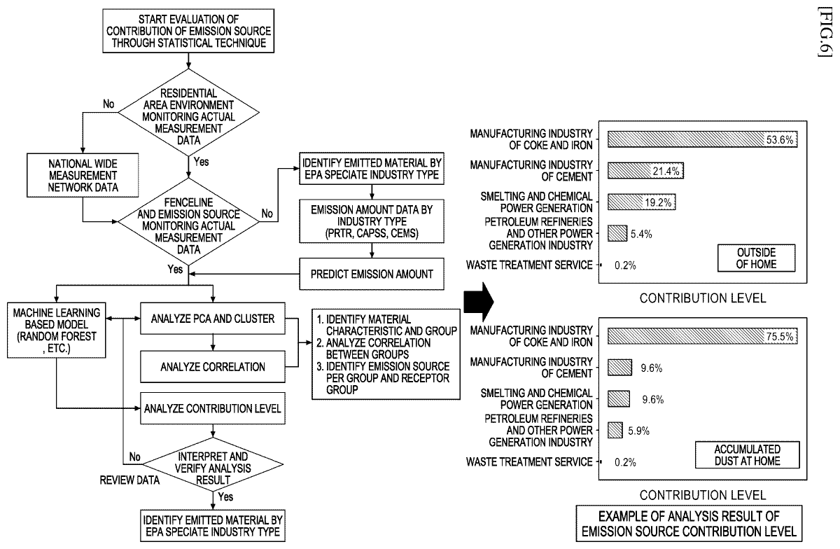

FIG. 5 is a flowchart of a fourth embodiment of an emission source contribution evaluation method which checks an exposure contribution level of an environmental harmful factor.

Information about multiple emission sources is stored in step S31.

At least one of the residential area environment monitoring actual measurement data and the emission source monitoring actual measurement data is received in step S32.

A concentration analysis, correlation analysis, principal component analysis, factor analysis, and cluster analysis are performed based on at least one of residential area environmental monitoring data or emission source monitoring data in step S33.

A contribution level of each of multiple emission sources is evaluated based on an analysis result and information about multiple emission sources in step S34.

The concentrations and ratios of hazardous substances for each of multiple receptors and emission sources are displayed using statistical techniques in step S35.

The evaluated contribution level of each of multiple emission sources is displayed for each of multiple exposure sources in step S36.

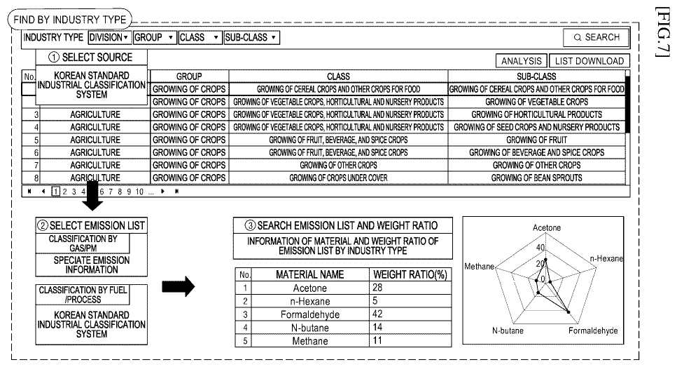

FIG. 6 is a flowchart and a result exemplary diagram of emission source tracking and contribution level evaluation of an emission source contribution evaluation system which checks an exposure contribution level of an environmental harmful factor.

In the exemplary result table, an example of emission source contribution analysis result of dusts at the outside of the home and accumulated at home.

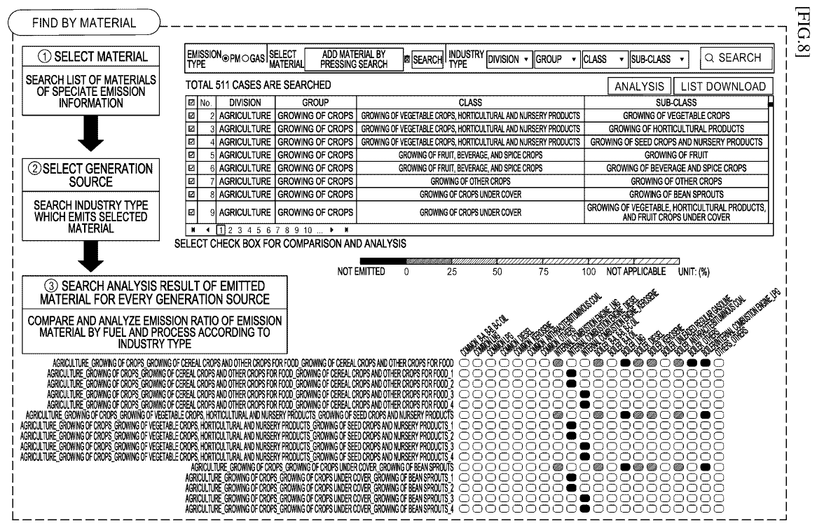

FIG. 7 is an exemplary diagram of finding by industry in inquiry of an air pollutant source and an emission list status.

A source is selected to search an industry type from the Korean standard industrial classification system. Thereafter, classification by GAS/PM and classification by fuel/process are performed and the emission list is selected to search emission information. Thereafter, a material and weight ratio information of the emission list by industry type are identified.

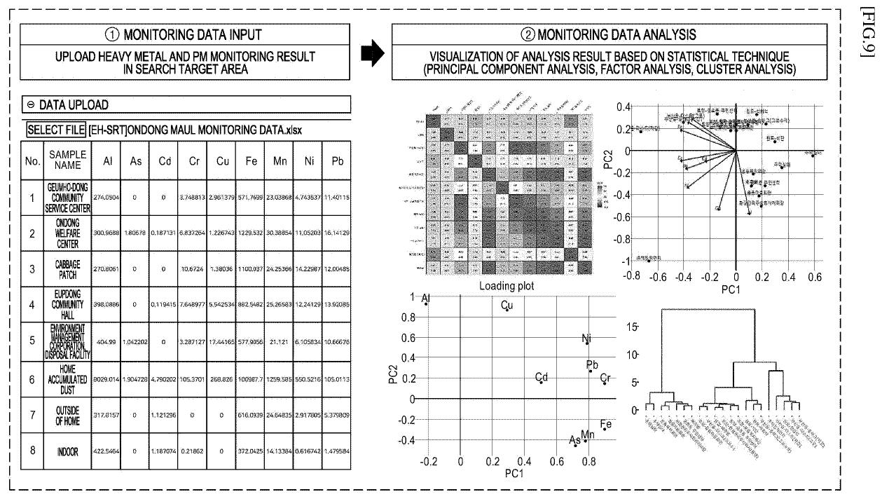

FIG. 8 is an exemplary diagram of finding by material in inquiry of an air pollutant source and an emission list status.

An emission information material list is searched. Thereafter, an industry type which emits the selected material is searched. Thereafter, an emission ratio of emitted material by fuel and process is compared and analyzed according to the industry type.

FIG. 9 is an exemplary view of data analysis based on a statistical technique for tracking an emission source and evaluating a contribution level.

A monitoring result of heavy metal and PM in a survey area is uploaded to input data. The analysis result based on the statistical technique (principal component analysis, factor analysis, cluster analysis) is visualized to analyze monitoring data.

A modified embodiment, other than the above-described embodiments, will be described.

Meteorological and topographical information between the emission source and the receptor are identified, and the transport path of hazardous substances from the emission source to the receptor is analyzed using an artificial intelligence model. Based on this analysis, the proportion of hazardous substances reaching the receptor and the proportion filtered along the path may be calculated using the meteorological and topographical information. By doing so, the exposure concentration of hazardous substances at the receptor can be more accurately calculated.

Here, if the size, weight, scattering rate, moisture absorption rate, and emission temperature of hazardous substances emitted from each emission source are analyzed and applied to the atmospheric dispersion model, the concentration of hazardous substances reaching the receptor can be more accurately predicted. The controller continuously collects residential area environmental monitoring data, emission source monitoring data, the identified meteorological and topographical information between the emission source and the receptor, as well as the evaluated size, weight, scattering rate, moisture absorption rate, and emission temperature of hazardous substances emitted from each emission source, and may update the atmospheric dispersion model based on this data.

The controller evaluates the contribution level of each of multiple emission sources to generate an improvement method of each emission source and transmit the improvement method to the company of the emission source to improve a production process and an emission process. Therefore, the company of the emission source transmits the details of the improvement of the production process and the emission process to the controller and stores them. Thereafter, the size, weight, scattering rate, moisture absorption rate, and emission temperature of hazardous substances emitted from the emission source are collected, and the change in the contribution level to the exposure concentration of hazardous substances at the receptor resulting from the improvement may be identified. If it is determined that the exposure concentration of hazardous substances at the receptor is reduced based on this, continuous improvement may be promoted.

Here, an improvement plan to reduce the exposure concentration of hazardous substances at the receptor may be developed based on the meteorological and topographical information between the emission source and the receptor. In other words, the improvement plan may include measures such as removing hazardous substances using a water fog park installed between the emission source and the receptor, creating forests and parks, and installing wind turbines.

The atmospheric dispersion model may be updated using environmental and emission source monitoring data obtained between the emission source and the receptor. Such data may be acquired by deploying a drone along a predicted transport path of pollutants to collect samples using a pollution collection bag. The drone-based pollutant collection may be enhanced by accumulating data through repeated collections under similar meteorological conditions.

Here, the drone collects pollutants from regions near the emission source to regions near the receptor and updates the atmospheric dispersion model using data acquired by continuously tracking the transport path and distribution of the pollutants.

Here, the pollutant collection bag which is used for the drone may be a pollutant collection fabric which is broadly spread up, down, left, and right in the predicted pollutant movement path. Here, a balloon may be disposed for a long time to acquire the pollutants, rather than the drone. The collection cloth may be soaked in a solvent so as to acquire organic hazardous substances for subsequent analysis. By doing this, the concentrations of various organic hazardous substances can be identified.

Airborne hazardous substances are analyzed in real time using a remote optical measurement vehicle between the emission source and the receptor. Based on actual measurements, not only the concentrations of pollutants in the air but also the amounts of fine dust-generating substances emitted by specific pollutants and industrial complexes may be calculated. The atmospheric dispersion model may then be more accurately updated using the calculated emission amounts of hazardous substances.

The controller stores multiple emission sources, the emission amounts of hazardous substances from multiple emission sources, and an atmospheric dispersion model for the emission amounts of hazardous substances. When at least one of actual measurement data or monitoring data on the emission amounts of hazardous substances from multiple emission sources is received from the communication unit, the controller calculates the exposure concentrations of hazardous substances for the various receptors based on the atmospheric dispersion model and evaluates the risks of hazardous substances from multiple emission sources based on the calculated exposure concentrations.

When at least one of the actual measurement data or monitoring data is not received from the communication unit, but emission amounts categorized by company and industry type are received for multiple emission sources, the controller may predict the concentrations of hazardous substances for multiple emission sources based on the received data and the atmospheric dispersion model.

The controller may calculate contribution levels for various receptors based on the predicted concentrations of hazardous substances from multiple emission sources.

The controller generates a grid and calculates the concentrations of hazardous substances corresponding to the position information using the atmospheric dispersion model, and evaluates the risks of the hazardous substances from multiple emission sources based on the population within the calculated grid.

The controller may control the display unit to present the concentrations of hazardous substances in the calculated grid on a map.

The controller may evaluate integrated risks associated with exposure to two or more hazardous substances.

The controller stores a safe concentration range for exposure concentrations of hazardous substances when the receptor is human, and receives actual measurement data and monitoring data to calculate exposure concentrations for various receptors based on the atmospheric dispersion model. If the calculated exposure concentration exceeds the safe range, the controller may send a text message to the terminal of the receptor in the corresponding region, advising them to refrain from going outside.

Here, even though the calculated exposure concentration does not exceed the normal concentration range, an exposure restriction time is stored and exposure restriction time information is sent to the terminal of the exposure source of the corresponding region.

The comprehensive evaluation may be performed by adding exposure evaluation by environment and exposure evaluation by usage of products. By doing, if the risk is high, a warning may be transmitted to the emission source.

According to the emission source contribution evaluation system and method for evaluating exposure contributions of environmental harmful factors, the contribution level of each emission source may be assessed using information on multiple emission sources. This is achieved by applying an artificial intelligence model to analyze emission concentrations, correlation analysis, principal component analysis, factor analysis, and cluster analysis of hazardous substances based on residential area environmental monitoring data and emission source monitoring data. As a result, emissions of hazardous substances from companies that serve as emission sources can be managed to improve the atmospheric environment.

Further, emission amounts of hazardous substances may be predicted based on the types of emitted substances and the emission amounts from multiple emission sources.

Further, even in the absence of residential area monitoring data or emission source monitoring data, the atmospheric dispersion model may be used to predict the emitted concentrations of hazardous substances for each of the multiple emission sources affecting the residential areas.

Further, the movement and dispersion of hazardous substances may be more accurately predicted by considering various situations and conditions.

Further, the movement and dispersion of hazardous substances are quantified to accurately calculate the concentrations of hazardous substances for receptors across multiple regions.

Further, when the concentrations and ratios of hazardous substances for each emission source are displayed on a display unit, the corresponding concentrations and ratios for both receptors and emission sources can be identified and managed at a glance.

Further, emissions of hazardous substances from emission sources may be managed and reduced according to their contribution levels.

What is claimed is:

1. An emission source contribution evaluation system which checks an exposure contribution level of an environmental harmful factor, comprising: a communication unit which receives at least one of residential area environment monitoring actual measurement data and emission source monitoring actual measurement data from the outside; and a controller which stores information about multiple emission sources and, using an artificial intelligence model, performs concentration analysis, correlation analysis, principal component analysis, factor analysis, and cluster analysis based on at least one of residential area monitoring data and emission source monitoring data received from the communication unit, and evaluates a contribution level of each emission source based on the analysis results and the emission source information.

2. The emission source contribution evaluation system according to claim 1, wherein, when neither residential area monitoring data nor emission source monitoring data is received from the outside, the controller collects emissions from multiple emission sources and predicts the emission amounts of hazardous substances based on industry-specific emission data of the collected emissions.

3. The emission source contribution evaluation system according to claim 1, wherein the controller stores information about multiple emission sources, the emission amounts of hazardous substances from multiple emission sources, and an atmospheric dispersion model for the emission amounts. When neither residential area monitoring data nor emission source monitoring data is received from the outside, the controller collects actual measurement data or monitoring data on the emission amounts of hazardous substances from multiple emission sources and predicts the emitted concentrations of hazardous substances for each emission source based on the atmospheric dispersion model.

4. The emission source contribution evaluation system according to claim 3, wherein the actual measurement data and the monitoring data include position information comprising latitude and longitude of the emission source, wind direction, wind speed, distance scale, and concentrations of hazardous substances from the emission source.

5. The emission source contribution evaluation system according to claim 1, wherein the atmospheric dispersion model is formed by the following Equation:
$$level = \frac{Q}{{πσ}_{y} {σ}_{z} μ} exp [ - \frac{1}{2} {( \frac{H}{{σ}_{z}} )}^{2} ]$$
Q=pollution level of emission source (unit: g/s)
σ_{y}, σ_{z}=wind direction dispersion standard deviation of plume
μ=wind speed (unit: m/s)
H=effective chimney height (unit: m)
level=pollution level per grid
$${σ}_{y} = {a}_{y} \times {( \frac{x}{1000} )}^{{b}_{y}}$$
$${σ}_{z} = {a}_{z} \times {( \frac{x}{1000} )}^{{b}_{x}}$$
x=distance between emission source and center of grid (unit: m).

6. The emission source contribution evaluation system according to claim 1, further comprising: a display unit configured to display analysis results of concentration analysis, correlation analysis, principal component analysis, factor analysis, and cluster analysis, wherein the controller controls the display unit to display the concentrations and ratios of hazardous substances for each of the exposure sources and emission sources using a statistical technique.

7. The emission source contribution evaluation system according to claim 6, wherein the controller displays the evaluated contribution levels of the emission sources with respect to the receptors.
